(19) United States
(12) Patent Application Publication
(10) Pub. No.: US 2010/0264238 A1
(43) Pub. Date: Oct. 21, 2010

(54) SPRAY NOZZLE

(75) Inventors: Po-Hsiung WANG, Miao-Li Hsien (TW); Tzu-Meng Wang, Miao-Li Hsien (TW)

Correspondence Address: RABIN & Berdo, PC, 1101 14TH STREET, NW, SUITE 500, WASHINGTON, DC, 20005, US

(73) Assignee: KWAN-TEN ENTERPRISE CO., LTD., Miao-Li Hsien (TW)

(21) Appl. No.: 12/470,740

(22) Filed: May 22, 2009

(30) Foreign Application Priority Data
Apr. 16, 2009 (TW) 098206278

(51) Int. Cl. B05B 9/01

(52) U.S. Cl. 239/525

(57) ABSTRACT

A spray nozzle has a casing, an inside plug, an inside seal, an outside seal, an outside plug, an adjustment lever assembly and a nozzle head. The casing has a handle and a neck. The inside seal, outside seal, outside plug and nozzle head are mounted sequentially in and on the casing. The inside and outside seals are tubular and has sufficient surface areas to provide sufficient sealing characteristics. The adjustment lever assembly is longitudinal and mounted pivotally on the casing to allow fine adjustment of a flow rate of the spray nozzle.

### BACKGROUND OF THE INVENTION

1. Field of the Invention

The present invention relates to a nozzle, and more particularly to a spray nozzle to finely control water flow rate and prevent leakage.

2. Description of Related Art

Spray heads are generally used when planting, cultivating and nurturing plants such as flowers, vegetables and grass.

Because distribution densities and water requirements of flowers, vegetables and grass are different, a gardener must carefully adjust and control a flow rate of water provided by the spray head to output appropriate flow rates for different plants.

However, the conventional spray nozzle only adjusts the flow rate roughly by switching the flow rate between low, average and high degrees so that the gardener cannot precisely acquire desired flow rates for specific plants. Furthermore, the contact areas between O-rings and internal components in the conventional spray nozzle are not sufficient so the conventional spray nozzle leaks easily.

To overcome the shortcomings, the present invention provides a spray nozzle to mitigate or obviate the aforementioned problems.

### SUMMARY OF THE INVENTION

The main objective of the invention is to provide a spray nozzle to finely control water flow rate and prevent leakage.

A spray nozzle in accordance with the present invention has a casing, an inside plug, an inside seal, an outside seal, an outside plug, an adjustment lever assembly and a nozzle head. The casing has a handle and a neck. The inside seal, outside seal, outside plug and nozzle head are mounted sequentially in and on the casing. The inside and outside seals are tubular and have sufficient surface areas to provide sufficient sealing characteristics. The adjustment lever assembly is longitudinal and mounted pivotally on the casing to allow fine adjustment to the flow rate of the spray nozzle.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a first embodiment of a spray nozzle in accordance with the present invention;

FIG. 2 is a rear perspective view of the spray nozzle in FIG. 1;

FIG. 3 is an exploded front perspective view of the spray nozzle in FIG. 1;

FIG. 4 is an exploded rear perspective view of the spray nozzle in FIG. 2;

FIG. 5 is a side view in partial section of the spray nozzle in FIG. 1;

FIG. 6 is an operational side view in partial section of the spray nozzle in FIG. 5 showing the adjustment lever assembly pivoting;

FIG. 7 is a front perspective view of a second embodiment of a spray nozzle in accordance with the present invention;

FIG. 8 is a rear perspective view of the spray nozzle in FIG. 7;

FIG. 9 is an exploded front perspective view of the spray nozzle in FIG. 7;

FIG. 10 is an exploded rear perspective view of the spray nozzle in FIG. 8;

FIG. 11 is a cross sectional side view of the spray nozzle in FIG. 7; and

FIG. 12 is an operational cross sectional side view of the spray nozzle in FIG. 11 showing the adjustment lever assembly pivoting.

### DETAILED DESCRIPTION OF THE PREFERRED EMBODIMENT

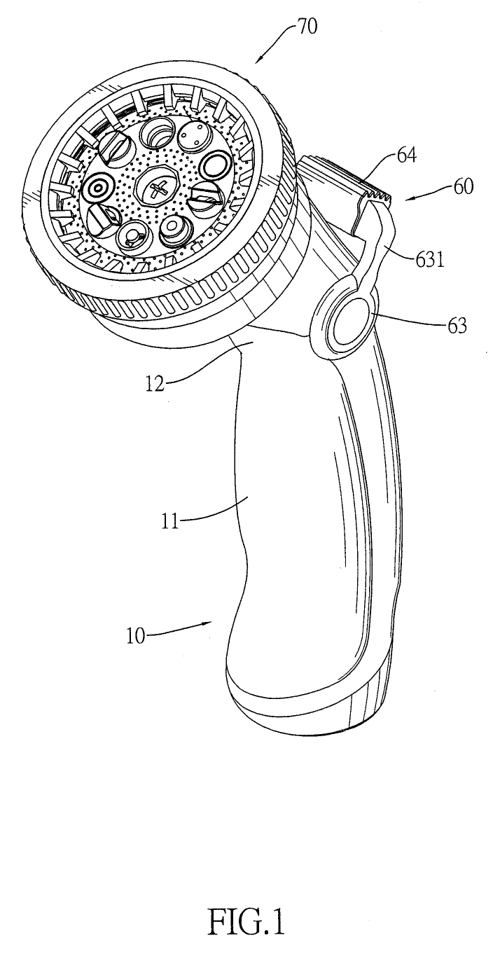

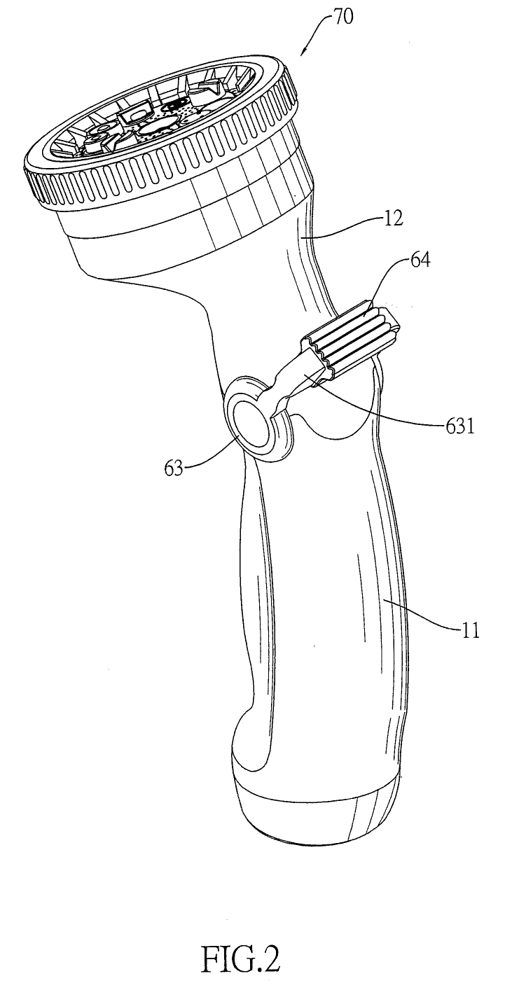

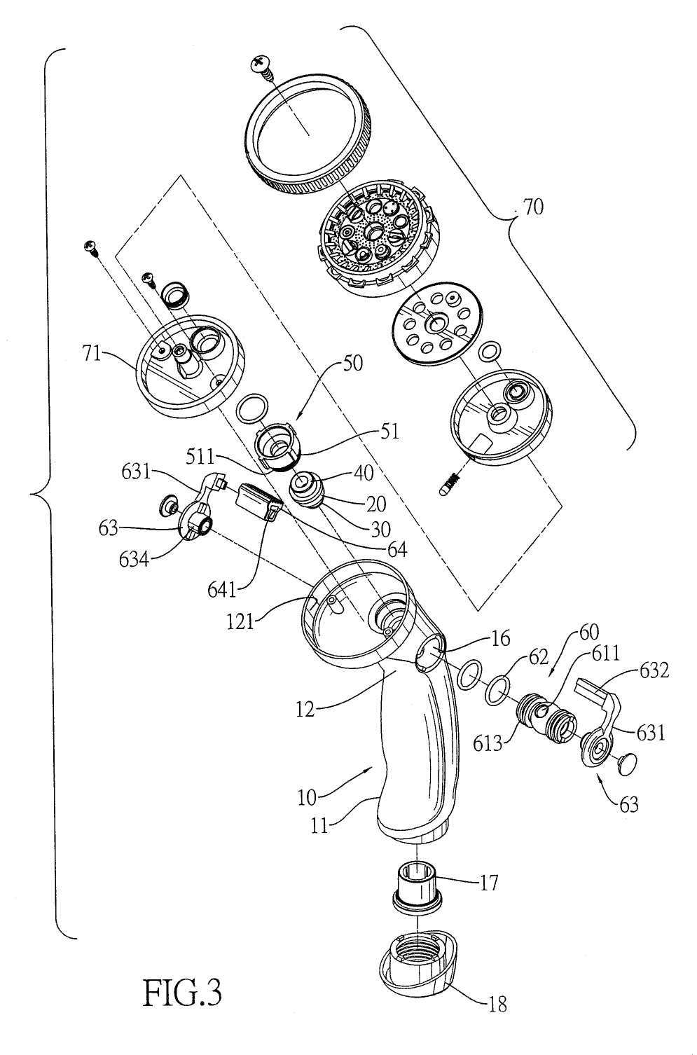

With reference to FIGS. 1 to 3, a first embodiment of the spray nozzle in accordance with the present invention comprises a casing (10), an inside plug (20), an inside seal (30), an outside seal (40), an outside plug (50), an adjustment lever assembly (60) and a nozzle head (70).

The casing (10) may be plastic and has a handle (11) and a neck (12) and may further have a thread fitting (18) and a mount (17).

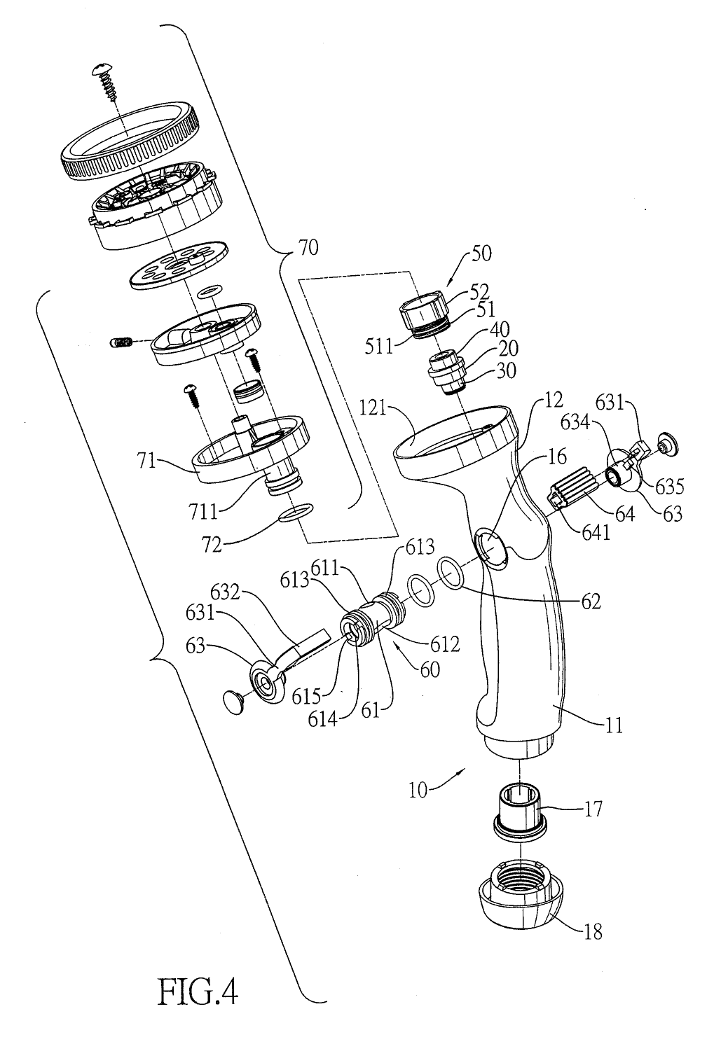

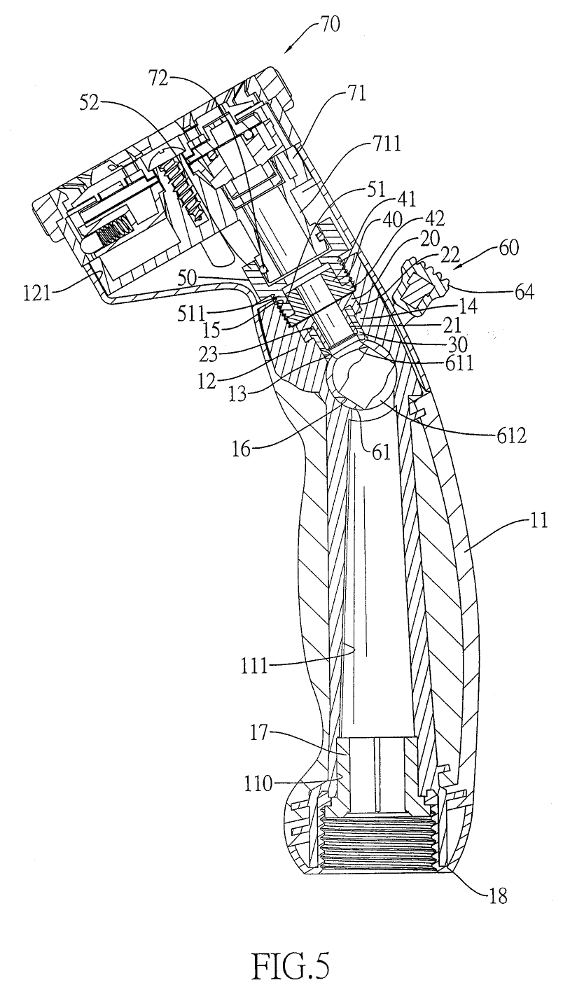

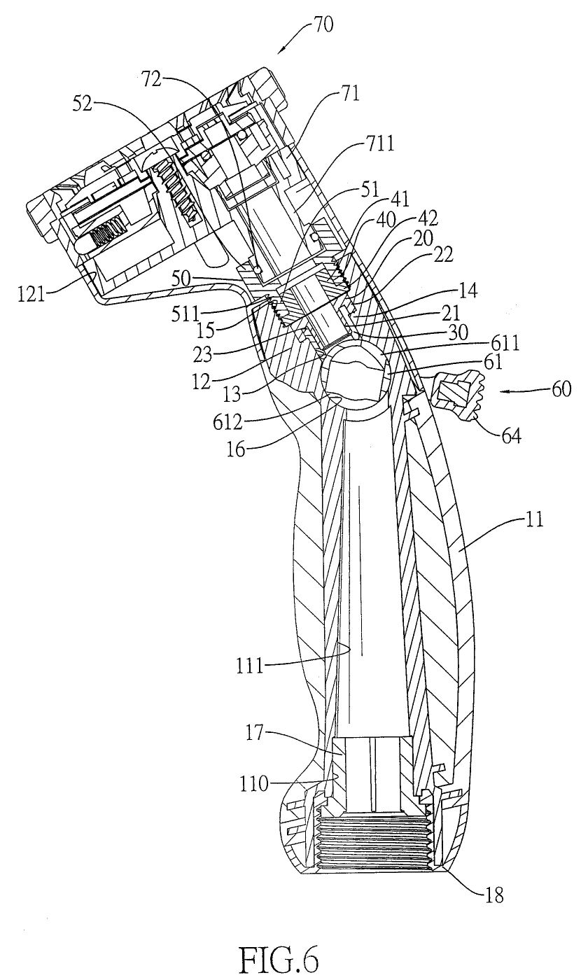

With further reference to FIGS. 4 to 6, the handle (11) has a channel (111). The channel (111) is defined longitudinally in the handle (111) and has an upper end and a lower open end (110).

The neck (12) is formed on the upper end of the handle (11) and has an upper open end (121), a mounting hole (13) and a transverse pivot hole (16) and may further have an inner annular shoulder (14). The mounting hole (13) is defined longitudinally in the neck (12), has an inner surface and may further have a first inner thread (15). The transverse pivot hole (16) is defined transversely through the neck (12) and is located between and communicates with the mounting hole (13) and the channel (111). The inner annular shoulder (14) is formed on and protrudes radially inwards from the inner surface of the mounting hole (13).

The thread fitting (18) is mounted in the lower open end (110) of the handle (11) and may be connected to a pipe.

The mount (17) is mounted through the thread fitting (18) in the channel (111) of the handle (11) to securely mount the thread fitting (18) to the handle (11).

The inside plug (20) is cylindrical, may be plastic, is mounted in the mounting hole (13) by an ultrasonic welding process and has a central hole and a mounting tube (21) and may further have an outer annular flange (22).

The central hole is defined through the inside plug (20) and communicates with the transverse pivot hole (16).

The mounting tube (21) has an inside end and an outside end. The inside end faces the transverse pivot hole (16).

The outer annular flange (22) is formed on and protrudes radially outwards from the outside end, abuts the inner annular shoulder (14) and has an inside surface, an outside surface and an annular groove (23). The annular groove (23) is defined in the inside surface and faces the transverse pivot hole (16).

The inside seal (30) is tubular and resilient, may be rubber, is mounted watertightly around the mounting tube (21) of the inside plug (20) and watertightly abuts the inner surface of the mounting hole (13) of the neck (12). The inside seal (30) may be mounted in the annular groove (23) of the inside plug (20) and extends over the inside end of the mounting tube (21).

The outside seal (40) is tubular and resilient, may be rubber, is mounted in the mounting hole (13) of the neck (12), watertightly abuts the outside end of the mounting tube (21) of the inside plug (20), has a connecting tube (41) and may further have an outer annular ring (42).

The connecting tube (41) has an inside end and an outside end. The inside end faces the inside seal (30).

The outer annular ring (42) is formed on and protrudes radially outwards from the inside end of the connecting tube (41) and watertightly abuts the outer annular flange (22) of the inside plug (20).

The outside plug (50) is cylindrical, may be metal, is mounted in the mounting hole (13) of the neck (12), watertightly abuts the outside seal (40) and has an inward bushing (51) and an outward bushing (52).

The inward bushing (51) is tubular, is mounted watertightly around the connecting tube (41), has an outer diameter, an inside end and an outside end and may further have a first outer thread (511). The inside end of the inward bushing (51) watertightly abuts the outer annular ring (42). The first outer thread (511) engages the first inner thread (15) in the casing (10).

The outward bushing (52) is tubular, is formed on and protrudes longitudinally outwards from the outside end of the inward bushing (52) and has an outer diameter larger than that of the inward bushing (51).

The adjustment lever assembly (60) is mounted pivotally on the casing (10) and has a valve (61) and an adjustment lever.

The valve (61) is substantially cylindrical, is mounted transversely and rotatably in the transverse pivot hole (16), watertightly abuts the inside seal (30) and has two ends, an inlet hole (612) and an outlet hole (611) and may further have a transverse hole (614), two annular recesses (613), two O-rings (62) and two sets of notches (615). The inlet hole (612) is defined in the valve (61) and communicates with the channel (111) of the handle (11). The outlet hole (611) is defined in the valve (61), communicates with the inlet hole (612) and selectively aligns with the inside seal (30) to communicate with the inside plug (20). The transverse hole (614) is defined through the valve (61) from one end to the other end and communicates with the inlet hole (612) and outlet hole (611). The annular recesses (613) are defined radially in the valve (61) respectively near the ends. The O-rings (62) are mounted respectively in the recesses (613) and seal the transverse pivot hole (16) of the casing (10). The sets of notches (615) are defined respectively in the ends of the valve (61).

The adjustment lever is longitudinal, is mounted securely on and seals the ends of the valve (61), extends from the neck (12) of the casing (10) and may have two lever members (63), a crossbeam (632) and a friction pad (64).

Each lever member (63) is mounted on one end of the valve (61) and has a lever portion (631) and may further have multiple protrusions (635). The lever portion (631) is formed on and protrudes from the lever member (63) and extends perpendicularly from one end of the valve (61). The protrusions (635) are formed on the lever member (63) and are engaged respectively with the notches (615) at one end of the valve (61).

The crossbeam (632) is formed on and protrudes perpendicularly from the lever portion (631) of one lever member (63) and is connected to the lever portion (631) of the other lever member (63).

The friction pad (64) is mounted around the crossbeam (632) and has a through hole (641) and multiple friction ribs. The through hole (614) holds the crossbeam (632). The friction ribs allow the friction pad (64) to be gripped to pivot the adjustment lever even when wet.

The nozzle head (70) is a shower nozzle head is mounted on the upper open end (121) of the neck (12) of the casing (10), is connected to the outside plug (50) and has a base (71), at least one ring and conventional components. The base (71) has a connecting hose (711) mounted in the outward bushing (52) of the outside plug (50). The O-ring (72) is mounted around the connecting hose (711) adjacent to the outward bushing (52). The conventional components are known by persons of ordinary skill in the art so descriptions thereof are omitted.

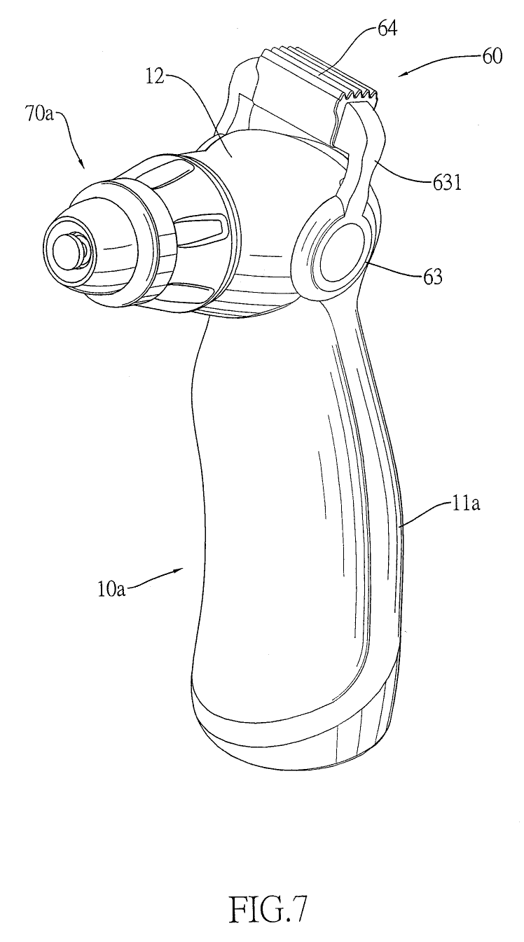

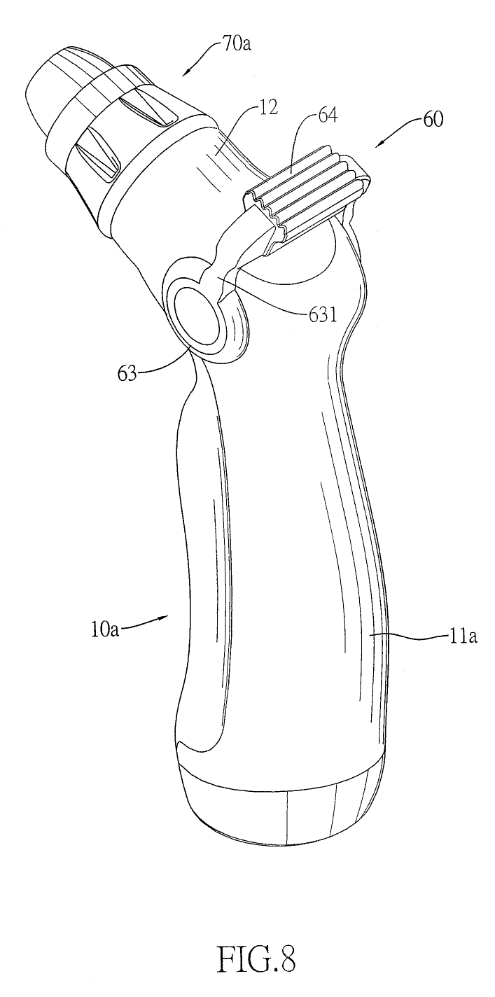

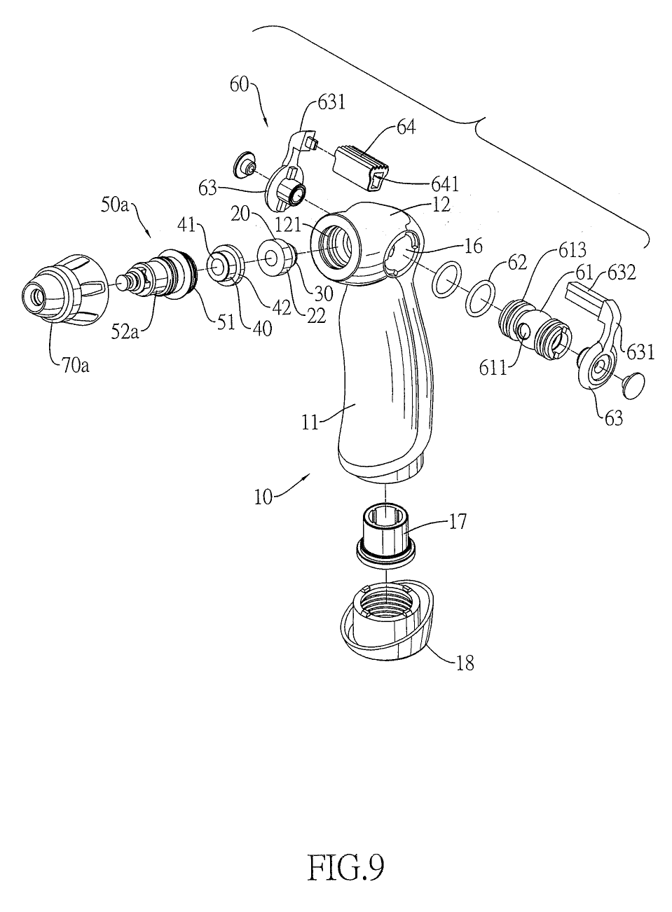

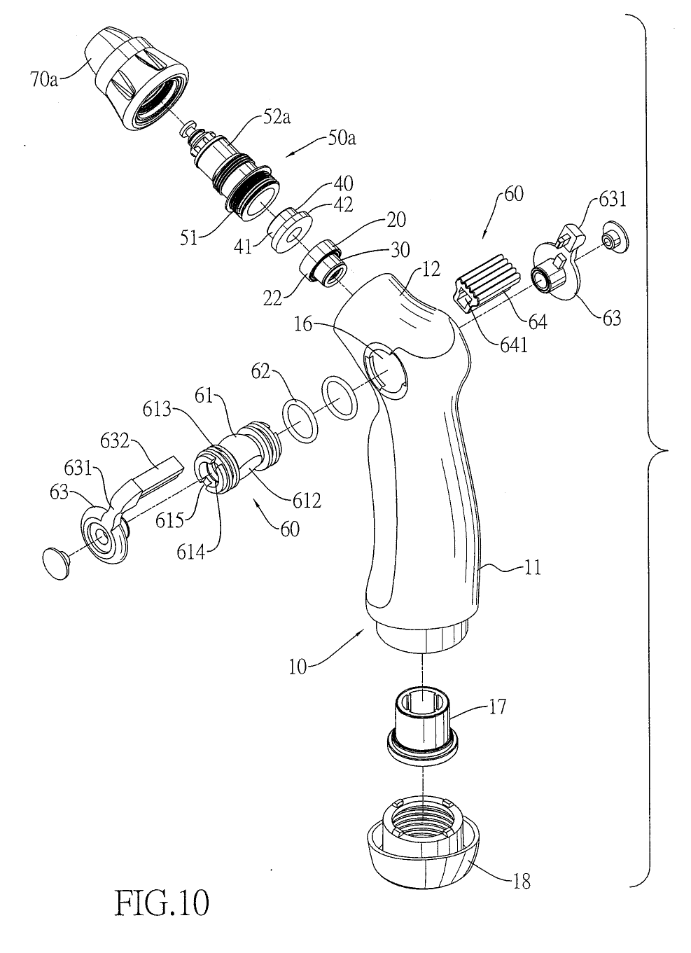

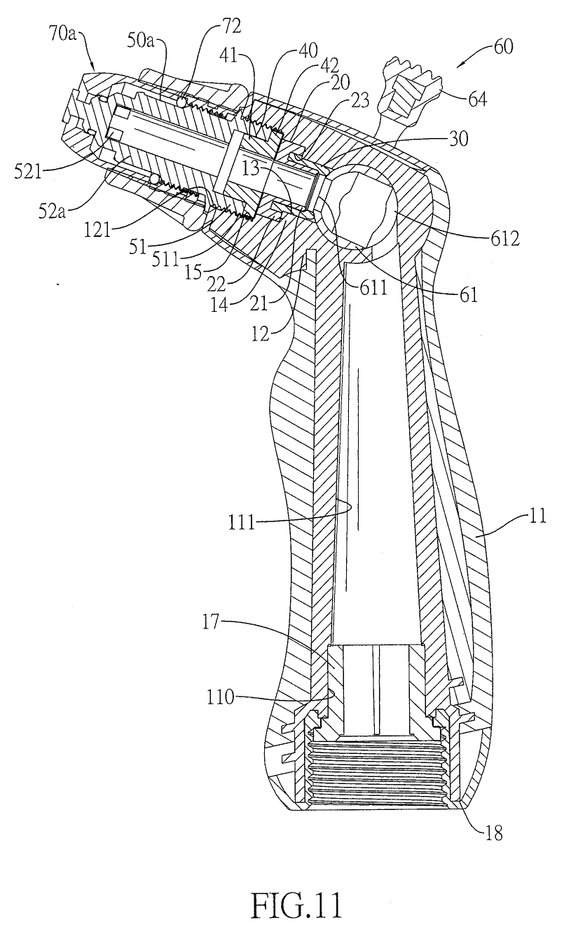

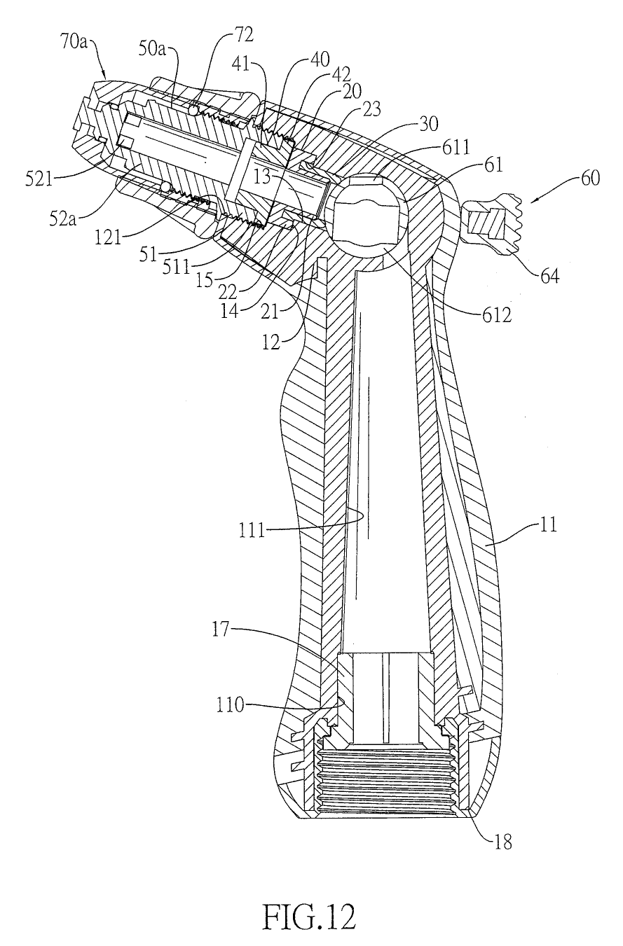

With reference to FIGS. 7 to 12, a second embodiment of the spray nozzle in accordance with the present invention is similar to the first embodiment and has the outside plug (50a) and the nozzle head (70a) different from those in the first embodiment.

The outside plug (50a) has a core (52a). The core (52a) is formed on and protrudes longitudinally from the outside end of the inward bushing (51) and has an outside end, multiple outlet bores (521) and a second outer thread. The outlet bores (521) are defined in the core (52a) near the outside end and communicate with the inward bushing (51).

The nozzle head (70a), is a conical cap, is mounted movably on and covers the core (52a) and has a spraying hole and a second inner thread. The spraying hole is defined through the nozzle head (70a). The second inner thread is engaged with the second outer thread of the core (52a). Rotating the nozzle head (70a) selectively opens or closes the outlet bores (521) of the core (52a).

Advantages of the spray nozzle follow:

1. The adjustment lever has a sufficient length so that a user may finely rotates the valve (61) by pivoting the adjustment lever to precisely control the alignment degree between the inside plug (20) and the outlet hole (612) of the valve (61). Full alignment acquires a maximum flow rate and full misalignment closes the spray nozzle. Therefore, the flow rate of the spray nozzle may be accurately controlled by the adjustment lever.

2. The inside and outside seals (30, 40) are tubular and have larger surface areas watertightly contacting the inner surface of the mounting hole (13), the inside plug (20) and the outside plug (50, 50a) when compared to conventional O-rings so improved sealing characteristics to prevent leakage are attained.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A spray nozzle comprising:
a casing having
a handle; and
a neck formed on the handle;
an inside plug being cylindrical, mounted in the neck and having
a central hole defined through the inside plug; and
a mounting tube having an inside end and outside end;
an inside seal being tubular and resilient, mounted watertightly around the mounting tube of the inside plug;
an outside seal being tubular and resilient, watertightly abutting the outside end of the mounting tube of the inside plug and having a connecting tube having an inside end and an outside end;
an outside plug being cylindrical, watertightly abutting the outside seal and having an inward bushing being tubular, mounted watertightly around the connecting tube and having an outer diameter, an inside end and an outside end;
an adjustment lever assembly mounted pivotally on the casing and having
a valve being substantially cylindrical, mounted transversely and rotatably in the neck, watertightly abutting the inside seal and having two ends, an inlet hole and an outlet hole communicating with the inlet hole and selectively aligning with the inside seal to communicate with the inside plug; and
an adjustment lever being longitudinal, mounted securely on the ends of the valve and extending out from the neck of the casing; and
a nozzle head mounted on the neck of the casing and connected to the outside plug.

2. The spray nozzle as claimed in claim 1, wherein
the handle has a channel defined in the handle and the handle having an upper end and a lower open end;
the neck is formed on the upper end and has
an upper open end;
a mounting hole defined longitudinally in the neck and having an inner surface; and
a transverse pivot hole defined transversely through the neck and communicating with the mounting hole and the channel;
the inside plug is mounted in the mounting hole of the neck and the central hole of the inside plug communicates with the transverse pivot hole;
the inside seal watertightly abuts the inner surface of the mounting hole;
the outside seal is mounted in the mounting hole of the neck;
the outside plug is mounted in the mounting hole of the neck;
the valve is mounted transversely and rotatably in the transverse pivot hole; and
the nozzle head is mounted on the upper open end of the neck.

3. The spray nozzle as claimed in claim 2, wherein
the neck further has an inner shoulder formed on and protruding radially inward from the inner surface of the mounting hole;
the inside plug further has an outer annular flange formed on and protruding radially outwards from the outside end, abutting the inner annular shoulder and having an inside surface, an outside surface an annular groove defined in the inside surface and facing the transverse hole; and
the inside seal is mounted in the annular groove of the inside plug and extends over the inside end of the mounting tube.

4. The spray nozzle as claimed in claim 3, wherein
the outside seal further has an outer annular ring formed on and protruding radially outwards from the inside end of the connecting tube and watertightly abutting the outer annular flange of the inside plug; and
the inside end of the inward bushing of the outside plug watertightly abuts the outer annular ring of the outside seal.

5. The spray nozzle as claimed in claim 4, wherein
the mounting hole of the neck further has a first inner thread; and
the inward bushing of the outside plug further has a first outer thread engaged with the first inner thread.

6. The spray nozzle as claimed in claim 5, wherein
the valve further has a transverse hole defined through the valve from one end to the other end and communicating with inlet hole and the outlet hole; and
the adjustment lever has
two lever members, each lever member mounted on one end of the valve and having a lever portion formed on and protruding from the lever member and extending perpendicularly from one end of the valve; and
a crossbeam formed on and protruding perpendicularly from the lever portion of one lever member and connected to the lever portion of the other lever member.

7. The spray nozzle as claimed in claim 6, wherein the adjust lever further has a friction pad mounted around crossbeam and having multiple friction pads.

8. The spray nozzle as claimed in claim 7, wherein the valve further has
two annular recesses defined radially in the valve respectively near the ends; and
two O-rings mounted respectively in the recesses and sealing the transverse pivot hole of the casing.

9. The spray nozzle as claimed in claim 8, wherein
the outside plug further has an outward bushing being tubular, formed on and protruding longitudinally outwards from the outside end of the inward bushing and having an outer diameter larger than that of the inward bushing; and
the nozzle head is a shower nozzle head and has a base having
a connecting hose mounted in the outward bushing of the outside plug; and
an O-ring mounted around the connecting hose adjacent to the outward bushing.

10. The spray nozzle as claimed in claim 8, wherein
the outside plug has a core formed on and protruding longitudinally from the outside end of the inward bushing and having
an outside end; and
multiple outlet bores defined in the core near the outside end and communicating with the inward bushing; and
the nozzle head is a conical cap, is mounted movably on and covers the core and has a spraying hole defined through the nozzle head.

11. The spray nozzle as claimed in claim 10, wherein
the core further has a second outer thread; and
the nozzle head further has a second inner thread engaged with the second outer thread of the core.

12. The spray nozzle as claimed in claim 8, wherein the casing and inside plug are plastic.

13. The spray nozzle as claimed in claim 8, wherein the inside plug is mounted in mounting hole of the neck by an ultrasonic welding process.

14. The spray nozzle as claimed in claim 8, wherein the outside plug is metal.

15. The spray nozzle as claimed in claim 8, wherein the casing further has
a thread fitting mounted in the lower open end; and
a mount mounted through the thread fitting in the channel of the handle to securely mount the thread fitting to the handle.
